(19) United States
(12) Patent Application Publication
(10) Pub. No.: US 2025/0392555 A1
(43) Pub. Date: Dec. 25, 2025

(54) SHARED HARDWARE INTERFACE FOR OPTIMIZING CROSSBAR

(71) Applicant: MELLANOX TECHNOLOGIES, LTD., Yokneam (IL)

(72) Inventors: Idan Matari, Lod (IL); George Elias, Tel-Aviv (IL); Ofir Klara Altshul, Herzliya (IL); Eyal Srebro, Kfar Yehoshua (IL); Elchanan Harshoshanim, Aley Zahav (IL)

(21) Appl. No.: 18/752,540

(22) Filed: Jun. 24, 2024

(51) Int. Cl. H04L 49/101

(52) U.S. Cl. CPC H04L 49/101

(57) ABSTRACT

An apparatus includes a crossbar circuit that routes one or more packets between one or more ingress nodes and one or more egress nodes. The plurality ingress nodes share the shared hardware interface. The shared hardware interface includes a pool of hardware interfaces, and the plurality of ingress nodes share the pool of hardware interfaces.

### FIELD OF TECHNOLOGY

The present disclosure relates to crossbar switches, and more particularly, to techniques for achieving high bandwidth capacity switching while reducing chip size.

### BACKGROUND

A crossbar switch may implement permutations of connections among ingress lines and egress lines. Techniques for achieving increases in data speed of a crossbar switch while reducing space requirements are desired.

### SUMMARY

Examples may include one of the following features, or any appropriate combination thereof.

An apparatus including: a crossbar circuit that routes one or more packets between a plurality of ingress nodes and one or more egress nodes; and a shared hardware interface, wherein each of the plurality ingress nodes is available to the crossbar circuit via the shared hardware interface.

In some aspects, the apparatus further includes a central hardware logic circuit associated with the shared hardware interface.

In some aspects, the shared hardware interface includes a pool of hardware interfaces, the plurality of ingress nodes shares the pool of hardware interfaces, and the central hardware logic circuit prevents traffic from the plurality of ingress nodes exceeding a respective throughput for a respective hardware interface of the pool of hardware interfaces.

In some aspects, the shared hardware interface includes a pool of hardware interfaces, the one or more egress nodes includes a plurality of egress nodes that share the pool of hardware interfaces, and the central hardware logic prevents traffic from the plurality of egress nodes exceeding a respective throughput for a respective hardware interface of the pool of hardware interfaces.

In some aspects, the apparatus further includes one or more buffers storing credits, wherein the credits resolve collisions between different ingress nodes.

In some aspects, the shared hardware interface manages credits on the one or more buffers when data sent from each ingress nodes arrives at one of the one or more egress nodes.

In some aspects, the central hardware logic circuit is configured to resolve a collision of data from two or more ingress nodes by choosing an oldest transaction from among the data.

In some aspects, the central hardware logic circuit prevents data sent from the plurality of ingress nodes to the one or more egress nodes via the hardware interface exceeding a threshold throughput for the hardware interface.

In some aspects, the one or more egress nodes are associated with a destination multiplexer, wherein the destination multiplexer and an associated destination buffer absorb a burst in traffic.

In some aspects, data is output by each ingress node to the shared hardware interface without direction by a central hardware logic circuit.

A switching device including: a crossbar circuit that routes one or more packets between a plurality of ingress nodes and one or more egress nodes; and a shared hardware interface, wherein each of the plurality ingress nodes is available to the crossbar circuit via the shared hardware interface.

In some aspects, the switching device further includes a central hardware logic circuit associated with the shared hardware interface.

In some aspects, the shared hardware interface includes a pool of hardware interfaces, the plurality of ingress nodes shares the pool of hardware interfaces, and the central hardware logic circuit prevents traffic from the plurality of ingress nodes exceeding a respective throughput for a respective hardware interface of the pool of hardware interfaces.

In some aspects, the switching device further includes one or more buffers storing credits, wherein the credits resolve collisions between different ingress nodes.

In some aspects, the shared hardware interface manages credits on the one or more buffers when data sent from each ingress nodes arrives at one of the one or more egress nodes.

In some aspects, the central hardware logic circuit is configured to resolve a collision of data from two or more ingress nodes by choosing an oldest transaction from among the data.

In some aspects, the central hardware logic circuit prevents data sent from the plurality of ingress nodes to the one or more egress nodes exceeding respective throughput for a respective hardware interface of the pool of hardware interfaces.

In some aspects, the one or more egress nodes are associated with a destination multiplexer, wherein the destination multiplexer and an associated destination buffer absorb a burst in traffic.

In some aspects, data is output by each ingress node to the shared hardware interface without direction by a central hardware logic circuit.

A system including a network device, the network device including a crossbar circuit that routes one or more packets between a plurality of ingress nodes and one or more egress nodes; and a shared hardware interface, wherein each of the plurality ingress nodes is available to the crossbar circuit via the shared hardware interface.

In some aspects, the network device further includes a central hardware logic circuit associated with the shared hardware interface.

In some aspects, the shared hardware interface includes a pool of hardware interfaces, the plurality of ingress nodes shares the pool of hardware interfaces, and the central hardware logic circuit prevents traffic from the plurality of ingress nodes exceeding a respective throughput for a respective hardware interface of the pool of hardware interfaces.

In some aspects, the network device further includes one or more buffers storing credits, wherein the credits resolve collisions between different ingress nodes.

In some aspects, the shared hardware interface manages credits on the one or more buffers when data sent from each ingress nodes arrives at one of the one or more egress nodes.

In some aspects, the central hardware logic circuit is configured to resolve a collision of data from two or more ingress nodes by choosing an oldest transaction from among the data.

In some aspects, the central hardware logic circuit prevents data sent from the plurality of ingress nodes to the one or more egress nodes via the hardware interface exceeding a threshold throughput for the hardware interface.

In some aspects, the one or more egress nodes are associated with a destination multiplexer, wherein the destination multiplexer and an associated destination buffer absorb a burst in traffic.

In some aspects, data is output by each ingress node to the shared hardware interface without direction by a central hardware logic circuit.

### BRIEF DESCRIPTION OF THE DRAWINGS

FIG. 1 illustrates an example of a system in accordance with aspects of the present disclosure.

FIG. 2 illustrates an example of ingress nodes and a shared interface in accordance with aspects of the present disclosure.

FIG. 3 illustrates an example of an egress node in accordance with aspects of the present disclosure.

FIG. 4 illustrates an example of a device in accordance with aspects of the present disclosure.

FIG. 5 illustrates an example process flow in accordance with aspects of the present disclosure.

### DETAILED DESCRIPTION

The ensuing description provides example aspects of the present disclosure, and is not intended to limit the scope, applicability, or configuration of the claims. Rather, the ensuing description will provide those skilled in the art with an enabling description for implementing the described examples. It being understood that various changes may be made in the function and arrangement of elements without departing from the spirit and scope of the appended claims. Various aspects of the present disclosure will be described herein with reference to drawings that are schematic illustrations of idealized configurations.

Crossbar switches are designed to implement permutations of connections among ingress lines and egress lines. The terms “crossbar switch,” “crossbar,” and “crossbar circuit” may be used interchangeably herein. Some techniques for achieving an increase in data speed (e.g., packets per second (PPS)) and/or providing high bandwidth capacity switching are desired which achieve a high message rate while mitigating increases in size (e.g., crossbar cell count) of the crossbar switch.

According to example aspects of the present disclosure, techniques described herein include, for data received at a group of ingress nodes of a packet switch, spreading the data over a pool of hardware interfaces, collectively referred to herein as a shared hardware interface. In some examples, the packet switch may include a crossbar switch. A single crossbar switch may include, or be in communication with, a plurality of shared hardware interfaces and each shared hardware interface may include any number of hardware interfaces. In various aspects, the techniques may include utilizing a central hardware logic circuit to direct traffic from the ingress nodes to the hardware interfaces of a shared hardware interface to avoid collisions in data impacting performance of the crossbar switch. In other aspects, other mechanisms may be employed to avoid such collisions.

After data from ingress nodes is received by hardware interfaces of a shared hardware interface, the data may be routed through a crossbar to an egress node of the packet switch. In some cases, as described in greater detail herein, egress nodes of the packet switch may be configured to absorb bursts in traffic to avoid or mitigate the influence on other ports which aren't directly involved in handling the burst as a result of the increased speed in packet traversal achieved through the systems and methods described herein. In addition to addressing undesired influence on other ports, embodiments of the present disclosure also contemplate the ability to preserve wire speed on some or all ports, thereby improving the overall performance of the switch. The techniques described herein may include an egress node utilizing a multiplexer (mux), a buffer, and/or other circuits to absorb such traffic.

Example aspects of the present disclosure support implementing techniques of spreading traffic from one or more ingress nodes across a pool of hardware interfaces. In some aspects, a central hardware logic circuit may prevent traffic from the ingress nodes exceeding a respective throughput for a respective hardware interface of the pool of hardware interfaces. In some aspects, buffers may be used to store or manage credits which may be used to resolve collisions in data sent via different ingress nodes when received at the shared hardware interface. In some aspects, the central hardware logic circuit may resolve collisions in data by selecting an oldest transaction from among the data and giving priority to the oldest transaction. In some aspects, no central hardware logic circuit may be required to achieve the sharing of hardware interfaces by the ingress nodes.

Accordingly, for example, aspects of the present disclosure describe a packet switch that may spread incoming data (e.g., packet data) from any number of ingress nodes among a plurality of hardware interfaces of a shared hardware interface. In an example, the packet switch may include a central hardware logic circuit. The central hardware logic circuit may control the direction of data from each ingress node toward each of the hardware interfaces to avoid or resolve collisions in the data. In some aspects, the packet switch may be designed without a central hardware logic circuit and collisions may either occur at an acceptable rate or may be resolved through other means. Each egress node of the packet switch may in some aspects be configured to absorb bursts in traffic through utilization of a mux and/or a buffer capable of handling excessive amounts of traffic.

The techniques described herein may provide improved message rate and/or bandwidth while decreasing the overall size of the packet switch. In an example, the techniques described herein may enable a reduced number of hardware interfaces and/or the removal of a central controller from the crossbar without incurring significant latency or negative impacts of traffic bursts.

Aspects of the disclosure are further illustrated by and described with reference to apparatus diagrams, system diagrams, and flowcharts that relate to the sharing of hardware interfaces by a group of ingress nodes, which may achieve high bandwidth capacity switching while mitigating increases in crossbar size.

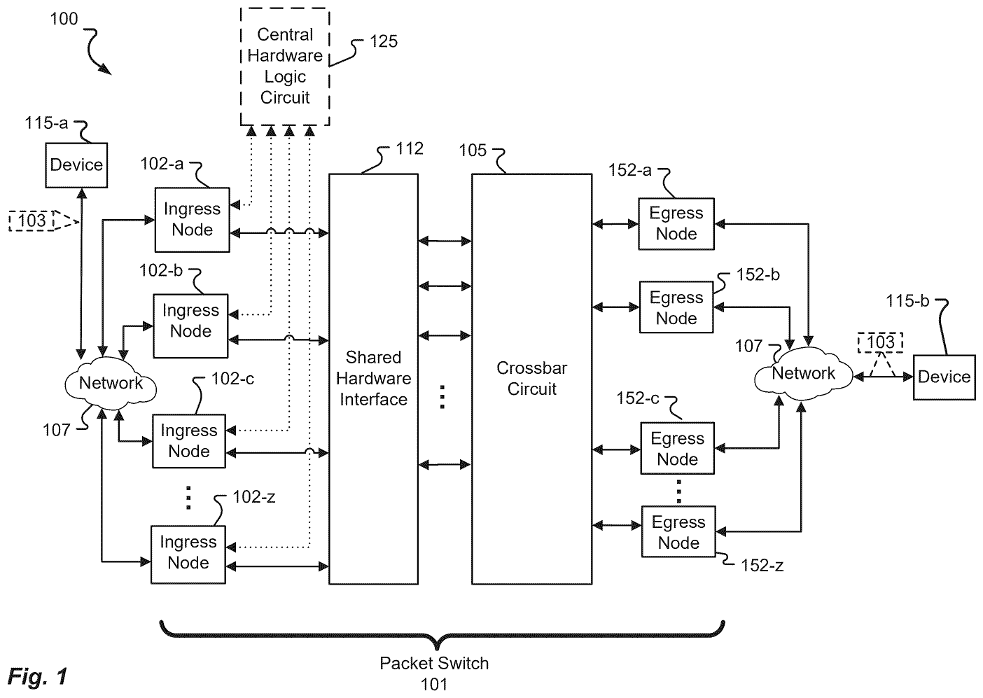

FIG. 1 illustrates an example of a system 100 supported by aspects of the present disclosure. The system 100 may include a packet switch 101. The packet switch 101 may include ingress nodes 102 (e.g., ingress node 102-a through ingress node 102-z), one or more shared hardware interfaces 112, a crossbar circuit 105, and egress domains 152 (e.g., egress domain 152-a through egress domain 152-z). The packet switch 101 and/or crossbar circuit 105 may include one or more central hardware logic circuits 125 for directing packets or data between ingress nodes 102 and a shared hardware interfaces 112. The packet switch 101 may communicate packets between different devices (e.g., communication devices, servers, etc.) connected to a communications network 107. In an example, the packet switch 101 may be implemented as an on-die chip.

The system 100 may support the communication of data packets 103 between entities (e.g., devices 115, communication devices, server(s), etc.) of the system 100, for example, via one or more packet switches 101 and communications network 107. Aspects of the communications network 107 may be implemented by any appropriate communications network capable of facilitating machine-to-machine communications between entities (e.g., any appropriate number of devices, computing devices, communication devices, servers, etc.). For example, the communications network 107 may include any appropriate type of known communication medium or collection of communication media and may use any appropriate type of protocols to transport messages, signals, and/or data between endpoints. In some aspects, the communications network 107 may include wired communications technologies, wireless communications technologies, or any appropriate combination thereof. In some examples, the communications network 107 may support non-secure communication channels and secure communication channels.

The Internet is an example of a network (e.g., a communications network 107) supported by the system 100, and the network may constitute an Internet Protocol (IP) network consisting of multiple computers, computing networks, and other devices located in multiple locations. Other examples of networks supported by the system 100 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VOIP) network, Ethernet, InfiniBand™, a cellular network, and any other appropriate type of packet-switched or circuit-switched network known in the art. In some cases, the system 100 may include any appropriate combination of networks or network types. In some aspects, the network may include any appropriate combination of communication mediums such as coaxial cable, copper cable/wire, fiber-optic cable, or antennas for communicating data (e.g., transmitting/receiving data).

A shared hardware interface 112 (which may also be referred to herein as a pool of hardware interfaces) may include a plurality of hardware interfaces. Each hardware interface of a shared hardware interface 112 may be used by any one or more ingress nodes 102 of a group of ingress nodes 102. While FIG. 1 illustrates a single shared hardware interface 112 in communication with four ingress nodes 102, it should be appreciated that in some example implementations a packet switch 101 may include multiple groups of ingress nodes 102. Each group of ingress nodes 102 may be associated with a shared hardware interface 112.

A crossbar circuit 105 as described herein may facilitate direct connections between multiple ingress nodes 102 and egress nodes 152. Each ingress node 102 can be independently connected to any egress node 152. A crossbar circuit 105 may include a matrix of electronically controlled switches at intersections. Each switch may allow for selective routing of signals across the crossbar circuit 105. The flow of data through the crossbar circuit 105 may be governed by control logic which may evaluate the destination of each data packet reaching the crossbar circuit 105 from the shared hardware interface 112 and dynamically configure switches of the crossbar circuit 105 to create a direct path to the corresponding egress node 152. As data exits the crossbar circuit 105 the data may reach a specific egress node 152 based on its destination device 115-b which it may access via the network 107.

In some example additional or alternative implementations, the packet switch 101 may include a central hardware logic circuit 125 (also referred to herein as a control circuit, central control circuit, central control plain block, central scheduler, central scheduling circuit, or central queuing system). In some aspects, the central hardware logic circuit 125 may control the routing of packets between ingress nodes 102 and specific hardware interfaces of a shared hardware interface 112. In some aspects, the central hardware logic circuit 125 may perform one or more of the following functions: prevent traffic from ingress nodes 102 exceeding a respective throughput for a respective hardware interface of the shared hardware interface, manage credits on one or more buffers when data is sent from an ingress node 102 to the shared hardware interface, resolve collisions of data from different ingress nodes 102 such as by choosing an oldest transaction from among the data, and/or other functions.

In some cases, the packet switch 101 may be implemented with or without the central hardware logic circuit 125. For example, the packet switch 101 may support certain operations and techniques described herein which do not involve the central hardware logic circuit 125 for routing traffic from ingress nodes to the shared hardware interface 112. In some examples, the packet switch 101 may bypass use of the central hardware logic circuit 125 for cases in which the packet switch 101 utilizes systems and methods of routing traffic which do not rely on the central hardware logic circuit 125.

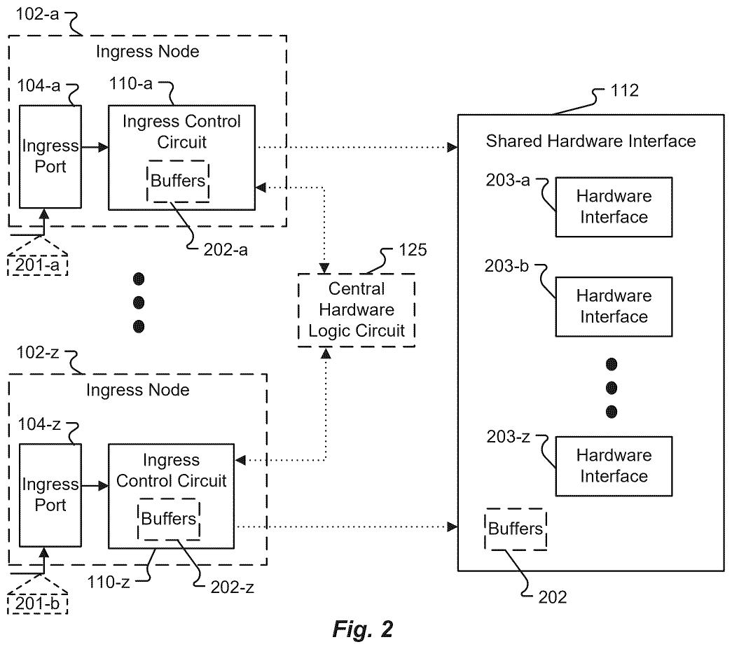

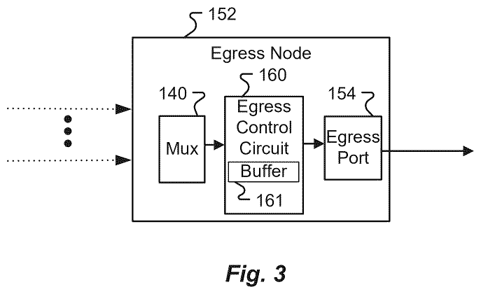

It is to be understood that ingress ports 104 (illustrated in FIG. 2) associated with the ingress nodes 102, crossbar circuit 105, central hardware logic circuit 125, and egress ports 154 (illustrated in FIG. 3) associated with the egress nodes 152, may be electrically coupled, for example via a communication bus or system bus of the packet switch 101. For simplicity, connections between the ingress ports 104 and the egress ports 154 are not illustrated herein. Example functions of the ingress ports 104, shared hardware interface 112, crossbar circuit 105, central hardware logic circuit 125, and egress ports 154 are explained in greater detail herein.

FIG. 2 illustrates example ingress nodes, a central hardware logic circuit 125, and a shared interface 112 of a packet switch 101 in accordance with aspects of the present disclosure.

Each ingress node 102 (e.g., ingress node 102-a through ingress node 102-z) may include an ingress port 104 and an ingress control circuit 110. Packets 201-a and 201-b may be received by a respective ingress node 102 via an ingress port 104. In the example illustrated in FIG. 2, a first ingress node 102-a receives a first packet 201-a via an ingress port 104-a and a second ingress node 102-z receives a second packet 201-b via an ingress port 104-z.

In some aspects, each ingress node 102 may be associated with one or more buffers 202. The buffers may in some implementations be in an ingress control circuit 110 associated with a respective ingress node 102. In the example illustrated in FIG. 2, a first ingress node 102-a is associated with a first buffer 202-a in an ingress control circuit 110-a and a second ingress node 102-z is associated with a second buffer 201-b in an ingress control circuit 110-z.

Each buffer 202 associated with an ingress node 102 may be further associated with a particular hardware interface 203 of the shared hardware interface 112 with which the ingress node 102 communicates. For example, a first ingress node 102-a and a second ingress node 102-z may each be in communication with a shared hardware interface 112 with Z hardware interfaces 203-a through 203-z. Each of the first and second ingress nodes 102-a, 102-z, may be associated with a respective set of Z buffers 202. Each buffer 202-a associated with the first ingress node 102-a may be associated with a different one of the Z hardware interfaces 203-a through 203-z and each buffer 202-z associated with the second ingress node 102-z may also be associated with a different one of the Z hardware interfaces 203-a through 203-z.

As described in greater detail below, a central hardware logic circuit 125 or another component may be configured to manage credits on each of the buffers 202-a through 202-z. As shown in FIG. 2, buffers 202 may reside within one or more ingress nodes 102a-z and/or within the shared hardware interface 112, When an ingress node 102 transmits data to a particular hardware interface 203 of the shared hardware interface 112, a credit may be removed from a buffer 202 associated with the ingress node 102 and the particular hardware interface 203. The ingress control circuit 110 of the ingress node 102 may be configured to select a hardware interface 203 from the shared hardware interface 112 based at least in part on a number of credits stored in each of the buffers. As should be appreciated by the description provided herein, in certain implementations no buffers 202 and/or central hardware logic circuits 125 may be necessary to implement the shared hardware interface 112 described herein.

FIG. 3 illustrates an egress node 152 in accordance with implementations described herein. Each egress node 152 may include a multiplexer 140 (which may be referred to herein as a mux), an egress control circuit 160, and an egress port 154. Each egress node 152 may include a buffer 161 for buffering data exiting the crossbar circuit 105. In some aspects, for each egress node 152, the respective buffer 161 may be integrated with or separate from the egress control circuit 160.

It is to be understood that example aspects of the present disclosure support any appropriate quantity of ingress nodes 102, buffers (e.g., buffer 202, buffer 161, etc.), central hardware logic circuits 125, shared hardware interfaces 112, hardware interfaces 203, crossbar circuits 105, and egress nodes 152 as described herein. The components of the packet switch 101 may communicate with one another over a system bus (e.g., control buses, address buses, data buses, etc.).

The crossbar circuit 105 may transfer data packets between respective ingress nodes 102 and egress nodes 152. For example, the crossbar circuit 105 may be controlled to transfer each received packet (e.g., packet 103 illustrated in FIG. 1) in turn to the appropriate egress node 152. The crossbar circuit 105 may include a switch fabric and may selectively connect the hardware interfaces 203 with the egress nodes 152 according to at least destination addresses of received network packets (e.g., packets 201 illustrated in FIG. 2).

In conventional crossbar circuits, a significant footprint in the chip is the connectivity between the ingress nodes and the crossbar. This is particularly an issue in large-scale crossbar circuits with many ingress nodes. However, by using a system as described herein, the footprint of the connectivity between ingress nodes and a crossbar circuits may be reduced by providing a hardware interface that is shared by a plurality of ingress nodes.

Conventional crossbar solutions use a dedicated connectivity resource for each node to assure bandwidth of the node. As a result, conventional crossbars incur an area penalty for the dedicated connectivity resource. The area cost for connecting all nodes to each other node with the required amount of bandwidth per node increases in a linear way along with the capacity of the crossbar circuit. As a result, large-scale crossbar circuits incur excessive amounts of area penalty. Different crossbar topologies such as Clos or Butterfly may seek to reduce the number of muxes between the nodes, but neither approach reduces the area cost which comes from the connectivity to conventional crossbar circuits.

By using a system as described herein, the area cost of a crossbar circuit inside a chip can be reduced. This reduction enables a significant improvement in the footprint of large-scale crossbar circuits. As described herein, a group of ingress nodes may share a pool of hardware interfaces, referred to herein as a shared hardware interface. This is enabled through an arrangement of logical circuits and other hardware. The system described herein may in some implementations be configured with one or more mechanisms for preventing or mitigating the impact of collisions between data sent via different ingress nodes within a group of ingress nodes to a shared interface.

A packet switch 101 may include a plurality of ingress nodes 102. As described above, each ingress node 102 may include a port 104 and an ingress control circuit 110. The ingress nodes 102 may be physically located at various points around the packet switch 101. For example, to facilitate direct access to external connections, ingress nodes 102 may be positioned around a perimeter of the packet switch 101.

In some implementations, ingress nodes 102 may be placed physically near one or more other ingress nodes 102. For example, ingress nodes 102 may be grouped. Groupings of ingress nodes 102 may be dependent on system architecture and design. For example, ingress nodes 102 which handle particular types of traffic may be placed relatively close to each other.

A packet switch 101 may include any number of groups of ingress nodes 102. Each group of ingress nodes 102 may be associated with a shared hardware interface 112. Each shared hardware interface 112 may include any number of one or more hardware interfaces 203. Each hardware interface 203 may be in communication with each ingress node 102 of the group of ingress nodes 102 associated with the shared hardware interface 112.

Communication between ingress nodes 102 and each hardware interface 203 may be enabled through the use of one or more multiplexers which may take as an input data from each of the ingress nodes 102 in a group and be configured to output to one or more of the hardware interfaces 203 of the shared hardware interface 112. For example, each hardware interface 203 of a shared hardware interface 112 may be connected to an output of a multiplexer and each ingress node 102 in the group of ingress nodes 102 may be connected to a respective input of the multiplexer as well as to an input of a multiplexer for each of the other hardware interfaces 203 of the shared hardware interface 112. In some implementations, each ingress node 102 may also include a multiplexer which can be used to selectively control the output of the ingress node 102 from between each of the hardware interfaces 203 of the shared hardware interface 112.

In some implementations, each hardware interface 203 of a shared hardware interface 112 may be associated with a respective hardware logic circuit. A hardware logic circuit may be enabled to control connections between ingress nodes 102 and a respective hardware interface 203. For example, and as described above, each hardware interface 203 may be associated with a dedicated multiplexer. The hardware logic circuit of the hardware interface 203 may be configured to control the input to the hardware interface 203 from between the ingress nodes 102 of the group of ingress nodes 102 which share the shared hardware interface 112. Each ingress node 102 in a group of ingress nodes 102 may be capable of writing to an input of the multiplexer. The hardware logic circuit may be capable of controlling the multiplexer to select which ingress node 102 writes to the respective hardware interface 203 at any given time. In this way, data from the ingress nodes 102 may be spread over the various hardware interfaces 203 of the shared hardware interface 112.

By sharing hardware interfaces 203 between different ingress nodes 102, the required connectivity between ingress nodes 102 to the crossbar circuit 105 may be reduced. For example, conventional crossbar circuits rely on ingress nodes which have dedicated hardware interfaces. As a result, conventional switches include ingress nodes and hardware interfaces on a one-to-one basis. Using a system as described herein, a packet switch 101 may include fewer hardware interfaces 203 than ingress nodes 102. As a result, a packet switch 101 as described herein may have a reduced number of hardware interfaces 203 and/or an increased number of ingress nodes 102.

A crossbar circuit 105 as described herein may include a number of multiplexers. Each multiplexer may be associated with a different egress node 152 and/or a particular destination. The multiplexers may be in communication with each of the shared hardware interfaces 112 connected to the crossbar circuit 105. Each multiplexer may be used to multiplex data from among all the interfaces toward a destination or egress node 152 associated with the respective multiplexer.

A packet switch 101 as described herein enables a single source, or ingress node 102, to communicate with a crossbar circuit 105 via multiple hardware interfaces 203. As a result, multiple ingress nodes 102 may be enabled to communicate with multiple egress nodes 152 at the same time. This ability of the packet switch 101 introduces a complexity in which data from one or more ingress nodes 102 may collide with other data either between the ingress nodes 102 and the shared interface 112 or within the crossbar circuit 105. Furthermore, the crossbar circuit 105 may experience increased traffic as compared to conventional crossbar circuits which, in conventional crossbar circuits, could result in congestion at the egress nodes. To resolve this issue, a packet switch 101 as described herein may be configured to avoid, resolve, and/or mitigate the impact of such collisions and congestion.

The present disclosure contemplates several mechanisms for avoiding, resolving, and/or mitigating the impact of collisions in data and congestion at egress nodes 152. The mechanisms described herein may be implemented alone or in combination. As should be appreciated, an implementation may include any number of one or more of the mechanisms described herein.

Certain mechanisms described below may be implemented in a packet switch 101 which does not include a central hardware logic circuit 125 while other mechanisms may require the use of a central hardware logic circuit 125 or a similar controller. Packet switches 101 which utilize a central hardware logic circuit 125 may be clock-accurate or cycle-accurate systems. In non-clock-accurate or cycle-accurate systems, mechanisms may be deployed without relying on a central hardware logic circuit 125.

Without a central controller, the packet switch 101 may be enabled to perform ad hoc decisions to avoid collisions. As an example, the packet switch 101 may include a shaper circuit for each egress node 152. To prevent over-subscription on the shared hardware interface, the shaper circuit may control an amount of traffic toward the associated destination such that the traffic does not overcome a threshold or throughput value.

Such a shaper circuit may monitor traffic heading towards the associated destination and actively manage the data flow towards the destination. For example, a shaper circuit may be dedicated to a single egress node 152. The shaper circuit may monitor the volume of data, or number of packets, reaching the egress node 152 at any given time.

Each shaper may be associated with a threshold data rate (e.g., bits per seconds (bps) or PPS). The threshold data rate may be user-configurable and/or may be based on system capabilities.

When the shaper circuit detects the volume of data exceeding the data rate, the shaper circuit may initiate an action to mitigate the condition. A shaper circuit may, for example, in response to detecting the volume of data exceeds the data rate, perform actions such as reducing the rate at which additional data directed to the destination is requested, implementing congestion control mechanisms, or performing other actions.

In some implementations, buffers 202 may be managed to avoid or resolve collisions between different ingress nodes 102 sharing a shared hardware interface 112. Each buffer 202 may store a number of credits. When an ingress node 102 forwards data via a particular hardware interface 203, a credit may be removed from the buffer 202 associated with the particular hardware interface 203. The removal of credits may be performed by a central hardware logic circuit 125, an ingress control circuit 110, a logic circuit associated with the shared hardware interface 112, or another circuit.

As referenced above, each ingress node 102 may include or be associated with one or more buffers 202. In some implementations, each ingress node 102 may include or be associated with a separate buffer 202 for each hardware interface 203 of the shared hardware interface 112.

In some other implementations, a shared hardware interface 112 may include buffers 202. Each hardware interface 203 of the shared hardware interface 112 may host one buffer 202 for each ingress node 102 sharing the shared hardware interface 112. As the hardware interface 203 receives data from a particular ingress node 102, the hardware interface 203 may remove a credit from the buffer 202 associated with the particular ingress node 102.

Once a buffer 202 is depleted of credits, the ingress node 102 may cease forwarding data via the hardware interface 203 associated with the buffer 202. Over time, spent credits may be released back to a buffer 202. For example, a credit spent due to a packet 201-a being forwarded via a particular hardware interface 203 may be released when the packet 201-a reaches its destination egress node 152.

Illustratively, the use of credits in buffers 202 may be used to resolve collisions between different ingress nodes 102 sharing a shared hardware interface 112. For example, the credits may lessen the likelihood of multiple ingress nodes 102 persistently writing to the same hardware interface 203. In this way, it can be ensured that there is no contention on the hardware interfaces 203 of the shared hardware interface 112 due to collisions between ingress nodes 102 using the same hardware interface 203. This enables high utilization on the shared interfaces.

In some implementations, a shared hardware interface 112 may be operable without the use of a central hardware logic circuit 125. The use of one buffer 202 per ingress node 102 per hardware interface 203 of a shared hardware interface 112 used by the ingress node 102 may be one way to enable the use of a shared hardware interface 112 without requiring a central hardware logic circuit 125; however, it should be appreciated that a central hardware logic circuit 125 may also or alternatively be used to control the use of buffers as described herein. Moreover, the mechanisms of avoiding collisions or mitigating the impact of collisions described herein may be used alone or in combination. As such, while the central hardware logic circuit 125 may not be required for one mechanism, the central hardware logic circuit 125 may be used for other mechanisms.

In some implementations, a hardware interface 203 of a shared hardware interface 112 may be configured to receive data from multiple ingress nodes 102 and to resolve any collisions. As an example, a hardware interface 203 may be configured to select an oldest packet or a packet which was scheduled earliest. The hardware interface 203 may then process packets in a selected order by forwarding the packet to a crossbar circuit 105. In this way, a hardware interface 203 may be configured to optimize data that was scheduled first, giving such data a higher priority, such that overall, the latency is reduced.

The use of a shared hardware interface 112 as described herein may result in an egress node 152 of a packet switch 101 receiving greater amounts of data as compared to conventional switches. In at least one implementation, egress nodes 152 of a packet switch 101 may be configured to absorb excessive amounts of data through the use of a multiplexer 140, a buffer 161, and/or other components. Such components may be sized appropriately such as to be capable of absorbing any burst in traffic. For instance, and without limitation, embodiments of the present disclosure may be configured to absorb a burst in traffic that exceeds a predetermined threshold (e.g., is larger than an average traffic bandwidth or a standard deviation above the average traffic bandwidth).

On the egress side, and as referenced above in relation to FIG. 3, each egress node 152 may include a multiplexer 140, an egress control circuit 160 including a buffer 161, and an egress port 154. As an example, an ingress portion of an egress node 152 may include a buffer 161. The buffer 161 may absorb any received data which is not immediately capable of being transmitted from an egress port 154 of the egress node 152. Through the use of a buffer 161 in an ingress portion of the egress node 152, the egress node 152 may absorb traffic to prevent congestion on the crossbar circuit 105.

In some implementations, the multiplexer 140 of an egress node 152 may be configured to respond to greater numbers of transactions than average by, for example, operating in a high-speed mode for a period of time. The multiplexer 140 may be capable of handling traffic from two or more sources at once and passing data to a buffer 161 of the egress node 152. A queue of transactions may build up in the buffer 161 until the transactions are handled and forwarded via an egress port 154 of the egress node.

As an illustration, consider a scenario in which each ingress node 102 can send a bandwidth of X into a crossbar circuit 105 and that an egress node 152 can forward data at a bandwidth of X. The egress node 152 may receive data at a higher rate than X due to multiple ingress nodes 102 transmitting data toward the egress node 152. The egress node 152 may store data in excess of the bandwidth of X in a buffer 161, creating a pool or buffer in the egress node 152 that enables reducing or eliminating congestion in the crossbar circuit 105.

In some implementations, a crossbar circuit 105 as described herein may be a managed crossbar circuit 105 and a central hardware logic circuit 125 may be used to direct traffic between ingress nodes 102 and the shared hardware interface 112. A central hardware logic circuit 125 may be particularly useful in a clock-accurate or cycle-accurate packet switch 101 in which operations and data transmissions of the packet switch operate with precise timing. A central hardware logic circuit 125 may be used to control the timing of packet forwarding, processing, and other operations based on clock cycles.

In some implementations, a central hardware logic circuit 125 may be configured to assign, or give ownership of, a particular hardware interface 203, to a particular ingress node 102 at any given time. In this way, each particular hardware interface 203 may be dynamically assigned to ingress nodes 102 and the routing of data from ingress nodes 102 to hardware interfaces 203 of a shared hardware interface 112 may change over time.

A central hardware logic circuit 125 may spread data from one or more ingress nodes 102 among the hardware interfaces 203 of a shared hardware interface 112 in such a way that the central hardware logic circuit 125 can decide which ingress node 102 can communicate with a particular egress node 152 at any given time, when to pass data from a particular ingress node 102 at any given time, and which hardware interface 203 can communicate with the crossbar circuit 105 at any given time.

A central hardware logic circuit 125 may be enabled to know what sources are communicating with what destinations. Based on such information, a central hardware logic circuit 125 may control the timing of the communications between ingress nodes 102 and the shared hardware interface 112 such that there are no collisions in the crossing points of the crossbar circuit 105.

In an example mechanism, a central hardware logic circuit 125 may apply one or more ingress node-specific rules on traffic reaching a shared hardware interface 112 from ingress nodes 102 such that each ingress node 102 is assured of a minimum level of bandwidth regardless of the amount of traffic being forwarded by other ingress nodes 102. Ingress node-specific rules may involve limiting data forwarded by particular ingress nodes 102 from exceeding a respective throughput for a particular hardware interface 203 of the shared hardware interfaces 112.

The central hardware logic circuit 125 may in some implementations prevent traffic from the plurality of ingress nodes exceeding a respective throughput for a respective hardware interface of the pool of hardware interfaces. Such a throughput may, for example, be a threshold amount set by a user or system designer or may be a hardware limitation based at least in part on factors such as a maximum rate of bandwidth (e.g., bps or PPS), an acceptable amount of latency and/or error rate, overall network and/or crossbar circuit congestion, and/or other factors. A throughput may be measured in terms of a maximum bps or PPS. The central hardware logic circuit 125 may control the traffic flowing out of each ingress node 102 such that the throughput for any given hardware interface 203 is not exceeded.

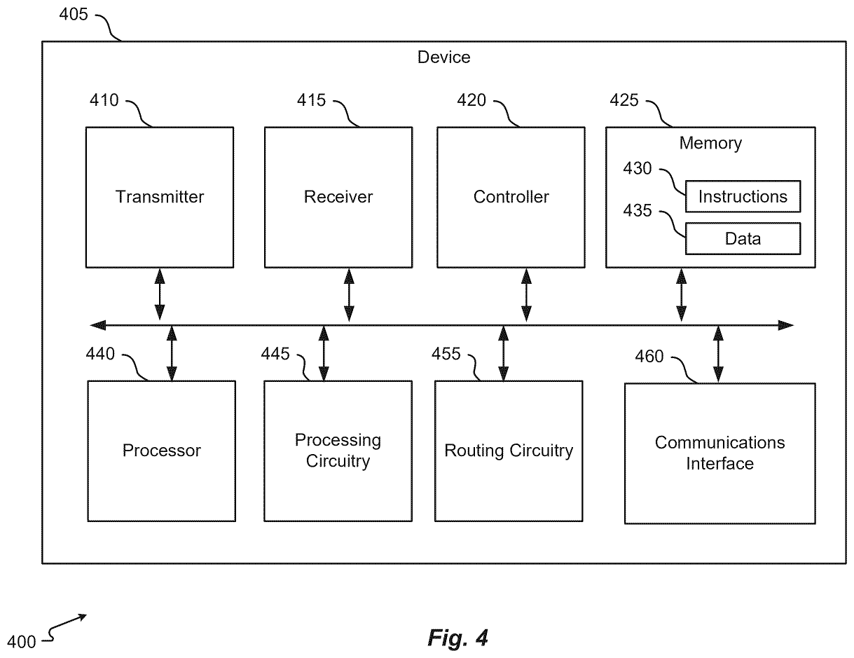

FIG. 4 illustrates an example of a system 400 in accordance with aspects of the present disclosure. The system 400 may include a device 405. In some cases, the device 405 may be referred to as a computing resource. The device 405 may perform any appropriate or all of the operations described in the present disclosure. The device 405 may implement aspects of a packet switch 101 described herein.

The device 405 may include a transmitter 410, a receiver 415, a controller 420, a memory 425, a processor 440, processing circuitry 445, routing circuitry 455, and a communications interface 460. In some examples, components of the device 405 (e.g., transmitter 410, receiver 415, controller 420, memory 425, processor 440, processing circuitry 445, routing circuitry 455, communications interface 460, etc.) may communicate over a system bus (e.g., control busses, address busses, data busses, etc.) included in the device 405. It is to be understood that aspects of the present disclosure may support omitting any of the components of the device 405, including additional instances of the components of the device 405, or including additional components not illustrated in FIG. 4. For example, in the case of a packet switch (e.g., packet switch 101), one or more functions of the device 405 may be implemented by processing circuitry 445 and routing circuitry 455, without processor 440.

The transmitter 410 and the receiver 415 may support the transmission and reception of signals to and from the device 405. In some aspects, the transmitter 410 and the receiver 415 may support the transmission and reception of signals within the device 405. The transmitter 410 and receiver 415 may be collectively referred to as a transceiver. An antenna may be electrically coupled to the transceiver. The device 405 may also include (not shown) multiple transmitters 410, multiple receivers 415, multiple transceivers and/or multiple antennas.

The controller 420 may be located on the same chip (e.g., ASIC chip) as the transmitter 410 and/or the receiver 415. In some cases, the controller 420 may be located on a different chip as the transmitter 410 and/or the receiver 415. In some examples, the controller 420 may be located on a chip of or on a chip of another device 405. In some examples, the controller 420 may be a programmed microprocessor or microcontroller. In some aspects, the controller 420 may include one or more CPUs, memory, and programmable I/O peripherals. The controller 420 may control the routing circuitry 455 to route data according to the techniques described herein.

The memory 425 may be any appropriate electronic component capable of storing electronic information. The memory 425 may be, for example, random access memory (RAM), read-only memory (ROM), magnetic disk storage media, optical storage media, flash memory devices in RAM, on-board memory included with the processor, EPROM memory, EEPROM memory, registers, and so forth, including combinations thereof.

The memory 425 may include instructions 430 (computer readable code) and data 435 stored thereon. The instructions 430 may be executable by the processor 440 to implement the methods disclosed herein. In some aspects, execution of the instructions 430 may involve one or more portions of the data 435. In some examples, when the processor 440 executes the instructions 430, various portions of the instructions 430 and/or the data 435 may be loaded onto the processor 440.

The processor 440 may correspond to one or multiple computer processing devices. For example, the processor 440 may include a silicon chip, such as a Field Programmable Gate Array (FPGA), an ASIC, any other appropriate type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute instructions sets stored in a corresponding memory (e.g., memory 425 of the device 405). For example, upon executing the instruction sets stored in memory 425, the processor 440 may enable or perform one or more functions of the device 405. In some examples, a combination of processors 440 (e.g., an advanced reduced instruction set computer (RISC) machine (ARM) and a digital signal processor (DSP)) may be implemented in the device 405.

The processing circuitry 445 may enable or perform one or more functions of the device 405. For example, the processing circuitry 445 may implement aspects of a packet switch (e.g., packet switch 101) and components thereof (e.g., central hardware logic circuit 125, etc.) described herein.

The routing circuitry 455 may implement aspects of a packet switch (e.g., packet switch 101) and crossbar circuit (e.g., crossbar circuit 105) described herein.

The communications interface 460 may support interactions (e.g., via a physical or virtual interface) between a user and the device 405.

According to example aspects of the present disclosure as described herein, an apparatus (e.g., a switching device such as a packet switch 101 and/or a system including a network device such as or including a packet switch 101) is described including: a crossbar circuit 105 that routes one or more packets 201 between one or more ingress nodes 102 and one or more egress nodes 152. In some aspects, the one or more ingress control circuits 110 are to distribute packet data from one or more ingress nodes 102 to one or more hardware interfaces 203 of a shared hardware interface 112. In some aspects, the apparatus may include a central hardware logic circuit 125 which may be configured to prevent traffic from the ingress nodes 102 from exceeding a throughput for the hardware interfaces 203 of the shared hardware interface 112. In other aspects, the apparatus may use mechanisms in addition to or instead of a central hardware logic circuit 125.

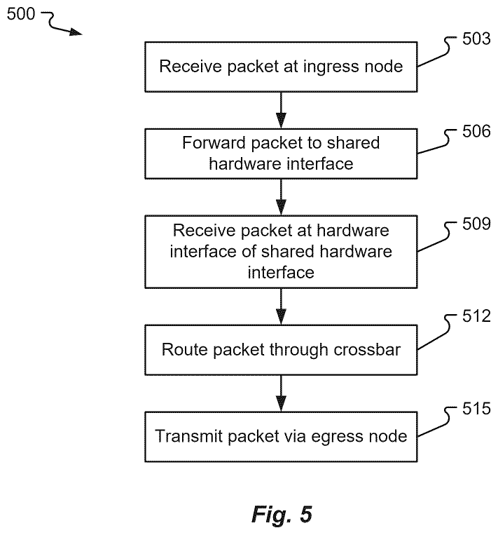

FIG. 5 illustrates an example of a process flow 500 in accordance with aspects of the present disclosure. In some examples, process flow 500 may be implemented by aspects of a packet switch 101 or a device 405 described with reference to FIGS. 1 through 4. For example, aspects of the process flow 500 may be implemented by a central hardware logic circuit 125, a packet switch 101, or processing circuitry 445 described herein.

In the following description of the process flow 500, the operations may be performed in a different order than the order shown, or the operations may be performed in different orders or at different times. Certain operations may also be left out of the process flow 500, or other operations may be added to the process flow 500.

Example aspects of the process flow 500 may be implemented by an apparatus, system, network device, or other componentry including a crossbar circuit 105. The crossbar circuit 105 receives data, e.g., packets, from one or more ingress nodes 102 via one or more shared hardware interfaces 112. The crossbar circuit 105 routes the data between the shared hardware interface(s) 112 and one or more egress nodes 152.

The process flow 500 may begin at 503 when a packet is received at an ingress node 102. The packet may be a packet 103 sent from a first device 115-a to a second device 115-b as illustrated in FIG. 1. The packet 103 may be received by a packet switch 101 from the first device 115-a via a network 107 and forwarded toward the second device 115-b via the same or a different network 107. The packet may arrive at an ingress port 104-a of a first ingress node 102-a. The first ingress node 102-a may be one of a number of ingress nodes 102 which are physically located relatively near each other and may be considered a group of ingress nodes 102. The ingress nodes 102 of the group of ingress nodes 102 may share a pool of hardware interfaces 203-a to 203-z as illustrated in FIG. 2. The pool of hardware interfaces may be considered a shared hardware interface 112.

At 506, the ingress node 102 may forward the received packet to a hardware interface 203 of the shared hardware interface 112. In some implementations, the ingress node 102 may direct the packet toward a particular hardware interface 203 of the shared hardware interface 112 while in other implementations the ingress node 102 may direct the packet toward a multiplexer of the shared hardware interface 112. Such a multiplexer may be controlled, for example, by a central hardware logic circuit 125. As should be appreciated, in certain implementations other mechanisms for directing the flow of packets between ingress nodes 102 and a shared hardware interface 112 may be utilized.

At 509, the packet may be received at a particular hardware interface 203 of the shared hardware interface 112. As described above, the particular hardware interface 203 may be selected by circuitry in either the ingress node 102, the shared hardware interface 112, a central hardware logic circuit 125, or another component. Once a packet is received at the particular hardware interface 203, the hardware interface may perform functions such as a processing or analysis of data of the packet, such as a header of the packet. In some implementations, the hardware interface 203 may make a routing decision based on the packet. Based on the processing and/or analysis of the packet data, the hardware interface 203 may forward the packet to the crossbar circuit 105.

At 512, the packet may be routed through the crossbar circuit 105. Based on the routing decision, and/or processing of the packet data, the crossbar circuit 105 may be enabled to configure an internal switching matrix to create a direct pathway from the hardware interface 203 to a designated egress node 152. The pathway from the hardware interface 203 to the designated egress node 152 may be configured such that the pathway does not interfere with pathways from other hardware interfaces 203 to the same or other egress nodes 152.

At 515, the packet may be transmitted via the designated egress node 152. In the case of a burst of traffic, the packet may for a period be stored in a buffer 161 of the egress node 152 until the egress node 152 can forward the packet from its egress port 154. After leaving the egress port 154, the packet may traverse a network 107 before arriving at a destination device 115-b.

The exemplary apparatuses, systems, and methods of this disclosure have been described in relation to examples of a crossbar circuit. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein. Furthermore, any of the steps, functions, and operations discussed herein can be performed continuously and automatically.

It will be appreciated from the descriptions herein, and for reasons of computational efficiency, that the components of devices and systems described herein can be arranged at any appropriate location within a distributed network of components without impacting the operation of the device and/or system.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

While the flowcharts have been discussed and illustrated in relation to a particular sequence of events, it should be appreciated that changes, additions, and omissions to this sequence can occur without materially affecting the operation of the disclosed examples, configuration, and aspects.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

In at least one example, architecture and/or functionality of various previous figures are implemented in context of a general computer system, a circuit board system, a game console system dedicated for entertainment purposes, an application-specific system, and more. In at least one example, the packet switch described herein may take the form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other appropriate type of logic.

Other variations are within the spirit of present disclosure. Thus, while disclosed techniques are susceptible to various modifications and alternative constructions, certain illustrated examples thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed examples (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one example, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any appropriate nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain examples require at least one of A, at least one of B and at least one of C each to be present. In addition, unless otherwise noted or contradicted by context, term “plurality” indicates a state of being plural (e.g., “a plurality of items” indicates multiple items). In at least one example, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one example, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one example, code is stored on a computer-readable storage medium, for example, in form of a computer program comprising a plurality of instructions executable by one or more processors. In at least one example, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one example, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one example, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one example, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one example, different components of a computer system have separate processors and different processors execute different subsets of instructions.

Accordingly, in at least one example, computer systems are configured to implement one or more services that singly or collectively perform operations of processes described herein and such computer systems are configured with applicable hardware and/or software that enable performance of operations. Further, a computer system that implements at least one example of present disclosure is a single device and, in another example, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate examples of disclosure, and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any appropriate device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one example, the terms “system” and “method” are used herein interchangeably insofar as a system may embody one or more methods and one or more methods may be considered a system.

In present document, references may be made to obtaining, acquiring, receiving, or inputting analog or digital data into a subsystem, computer system, or computer-implemented machine. In at least one example, process of obtaining, acquiring, receiving, or inputting analog and digital data can be accomplished in a variety of ways such as by receiving data as a parameter of a function call or a call to an application programming interface. In at least one example, processes of obtaining, acquiring, receiving, or inputting analog or digital data can be accomplished by transferring data via a serial or parallel interface. In at least one example, processes of obtaining, acquiring, receiving, or inputting analog or digital data can be accomplished by transferring data via a computer network from providing entity to acquiring entity. In at least one example, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. An apparatus comprising:
a crossbar circuit that routes one or more packets between a plurality of ingress nodes and one or more egress nodes; and
a shared hardware interface, wherein each of the plurality of ingress nodes is available to the crossbar circuit via the shared hardware interface.

2. The apparatus of claim 1, further comprising a central hardware logic circuit associated with the shared hardware interface.

3. The apparatus of claim 2, wherein:
the shared hardware interface includes a pool of hardware interfaces,
the plurality of ingress nodes shares the pool of hardware interfaces, and
the central hardware logic circuit prevents traffic from the plurality of ingress nodes exceeding a respective throughput for a respective hardware interface of the pool of hardware interfaces.

4. The apparatus of claim 2, wherein:
the shared hardware interface includes a pool of hardware interfaces,
the one or more egress nodes comprise a plurality of egress nodes that share the pool of hardware interfaces, and
the central hardware logic circuit prevents traffic from the plurality of egress nodes exceeding a respective throughput for a respective hardware interface of the pool of hardware interfaces.

5. The apparatus of claim 2, further comprising one or more buffers storing credits, wherein the credits resolve collisions between different ingress nodes.

6. The apparatus of claim 5, wherein the shared hardware interface manages credits on the one or more buffers when data sent from each ingress nodes arrives at one of the one or more egress nodes.

7. The apparatus of claim 2, wherein the central hardware logic circuit is configured to resolve a collision of data from two or more ingress nodes by choosing an oldest transaction from among the data.

8. The apparatus of claim 2, wherein the one or more egress nodes are associated with a destination multiplexer, wherein the destination multiplexer and an associated destination buffer absorb a burst in traffic.

9. The apparatus of claim 1, wherein data is output by each ingress node to the shared hardware interface without direction by a central hardware logic circuit.

10. A switching device comprising:
a crossbar circuit that routes one or more packets between a plurality of ingress nodes and one or more egress nodes; and
a shared hardware interface, wherein each of the plurality of ingress nodes is available to the crossbar circuit via the shared hardware interface.

11. The switching device of claim 10, further comprising a central hardware logic circuit associated with the shared hardware interface.

12. The switching device of claim 11, wherein:
the shared hardware interface includes a pool of hardware interfaces,
the plurality of ingress nodes shares the pool of hardware interfaces,
each hardware interface of the pool of hardware interfaces is associated with a respective hardware logic circuit, and
the central hardware logic circuit prevents traffic from the plurality of ingress nodes exceeding a respective throughput for a respective hardware interface of the pool of hardware interfaces.

13. The switching device of claim 11, further comprising one or more buffers storing credits, wherein the credits resolve collisions between different ingress nodes.

14. The switching device of claim 13, wherein the shared hardware interface manages credits on the one or more buffers when data sent from each ingress nodes arrives at one of the one or more egress nodes.

15. The switching device of claim 11, wherein the central hardware logic circuit is configured to resolve a collision of data from two or more ingress nodes by choosing an oldest transaction from among the data.

16. The switching device of claim 11, wherein the one or more egress nodes are associated with a destination multiplexer, wherein the destination multiplexer and an associated destination buffer absorb a burst in traffic.

17. The switching device of claim 11, wherein the central hardware logic circuit prevents data sent from the plurality of ingress nodes to the one or more egress nodes exceeding a respective throughput for a respective hardware interface of the pool of hardware interfaces.

18. The switching device of claim 10, wherein data is output by each ingress node to the shared hardware interface without direction by a central hardware logic circuit.

19. A system, comprising:
a network device including:
a crossbar circuit that routes one or more packets between a plurality of ingress nodes and one or more egress nodes; and
a shared hardware interface, wherein each of the plurality of ingress nodes is available to the crossbar circuit via the shared hardware interface.

20. The system of claim 19, further comprising a central hardware logic circuit associated with the shared hardware interface.

21. The system of claim 20, wherein:
the shared hardware interface includes a pool of hardware interfaces,
the plurality of ingress nodes shares the pool of hardware interfaces,
each hardware interface of the pool of hardware interfaces is associated with a respective hardware logic circuit, and
the central hardware logic circuit prevents traffic from the plurality of ingress nodes exceeding a respective throughput for a respective hardware interface of the pool of hardware interfaces.
